(19) United States
(12) Patent Application Publication
(10) Pub. No.: US 2009/0049392 A1
(43) Pub. Date: Feb. 19, 2009

(54) VISUAL NAVIGATION

(75) Inventors: Juha Karttunen, Vyska (FI); Mika Kaki, Tampere (FI); Risto Lahdesmaki, Espoo (FI); Tomas Lindberg, Helsinki (FI); Jesse Maula, Helsinki (FI); Miika Heiskanen, Helsinki (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/840,504

(22) Filed: Aug. 17, 2007

(51) Int. Cl. G06F 3/048; G06F 17/30

(52) U.S. Cl. 715/762; 707/100; 715/764; 715/823; 715/780; 707/E17.009

(57) ABSTRACT

A method for creating avatar visual identifiers of contacts in an address book, including receiving contact information, which contact information corresponds to an entry in an address book, extracting contact parameters associated with the contact information, associating the contact parameters with avatar identification parameters, and creating an avatar visual identifier for the contact information using the avatar identification parameters, wherein the avatar visual identifier has a one-to-one mapping to the contact information is provided. A device thereof is also provided.

### TECHNICAL FIELD

The disclosed embodiments relate to a method and device for creating, searching, and handling visual identifiers of data, for example for contacts in an address book.

### BACKGROUND

Mobile communication devices, such as mobile phones or personal digital assistants (PDAs), are today used for many different purposes. Typically, displays are used for output and keypads are used for input, particularly in the case of mobile communication devices.

For large devices, large screens and more refined input mechanisms allow for a rich and intuitive user interface. There is however a problem with user interfaces for small portable electronic devices, where displays are small and user input is limited. Any improvement in the user experience of such devices have an impact on usability and attractiveness.

In this context one particular problem is the allocation of attribute (or characteristic) information to e.g. contacts in address books of mobile phones. A related problem is how to efficiently find such contacts in an address book of a mobile phone. Yet another related problem is how to handle vast quantities of information, such as the individual entries of an address book, using only a small display.

Consequently, there is a need for an improved user interface for small portable electronic devices with a limited user interface.

### SUMMARY

In view of the above, it would be advantageous to solve or at least reduce the problems discussed above.

Generally, the above objectives are achieved by the attached independent patent claims.

According to a first aspect of the disclosed embodiments there is provided a method for creating avatar visual identifiers of contacts in an address book, comprising receiving contact information, which contact information corresponds to an entry in an address book, extracting contact parameters associated with the contact information, associating the contact parameters with avatar identification parameters, and creating an avatar for the contact information using the avatar identification parameters, wherein the avatar visual identifier has a one-to-one mapping to the contact information. The avatar visual identifier may also be displayed as an image, and the contact information may be displayed along the avatar visual identifier. The contact information may be at least one item from the list: phone number, address, email address, name, alias.

This method will thus automatically create an avatar visual identifier as a visual identifier of data, and more particularly it may be used to create avatars for contacts in an address book. Such visual identifiers will improve usability and user experience since visual identifiers enables fast and easy visual navigation through large data sets.

Note that by using the term avatar visual identifier we distinguish visual identifiers as created according to the disclosed embodiments from common visual identifiers in the form of e.g. pre-defined images in the address book (e.g. a facial image of the contact person). When such a distinction is not needed we use the common term visual identifier.

The one-to-one mapping from contact information to avatar identification parameters may be a predetermined one-to-one mapping, or the one-to-one mapping may be defined by receiving user input representing a one-to-one mapping from the contact parameters to the avatar identification parameters.

Thus the method gives the user a possibility to create visual identifiers in the form of avatars according to his/her own personal preferences.

The image of the avatar visual identifier may comprise at least one item from the group of: a head with hair, wherein the head have a shape and a colour, wherein the hair have a shape and a colour, wherein the head is attached to a body, wherein the body have a shape and a colour. The image may further comprise a background, wherein the background have a colour, and wherein the avatar identification parameters correspond to items from the list: shape of head, shape of body, shape of hair, colour of head, colour of body, colour of hair, colour of background. To increase user experience and pleasure facial features, such as eyes, a nose, and a mouth could be added as well to create more life-like avatar visual identifiers.

According to a second aspect of the disclosed embodiments there is provided a method for searching contact information in an address book, comprising receiving user input representing search terms for an avatar visual identifier, wherein the search terms correspond to avatar identification parameters, wherein the avatar visual identifier has a one-to-one mapping to contact information, and wherein the contact information corresponds to an entry in an address book; and the method further comprises displaying the avatar visual identifier as an image, wherein the image is displayed along the contact information, and wherein the avatar visual identifier has a one-to-one mapping to the contact information. The contact information may be at least one item from the list: phone number, address, email address, name, alias.

Hence the disclosed embodiments include a system comprising both creating avatar visual identifiers and using the created avatar visual identifiers to simplify searching for contacts in address books.

According to a third aspect of the disclosed embodiments there is provided a mobile communication device comprising circuitry configured to receive contact information, which contact information corresponds to an entry in an address book, extract contact parameters associated with the contact information, associate the contact parameters with avatar identification parameters, and create an avatar visual identifier for the contact information using the avatar identification parameters, wherein the avatar visual identifier has a one-to-one mapping to the contact information.

According to a fourth aspect of the disclosed embodiments there is provided a method for facilitating extraction of a data item from a set of data items, comprising receiving at least one set of data items; associating items from the at least one set of data items with visual identifiers; displaying a subset of visual identifiers along a path on a display, wherein members of the subset of visual identifiers are stacked in at least one stack of visual identifiers; detecting a first user input and calculating a position on the display based on the detection of the first user input; highlighting a member of the displayed stacked subset of visual identifiers on the display, wherein the highlighted visual identifier corresponds to the calculated position on the display; and detecting a second user input representing a selection of the highlighted visual identifier, extracting further data from the selected data item represented by the highlighted visual identifier and displaying the further data on the display.

The subset members of visual identifiers may have a size and at least one colour, and the highlighting of visual identifier may comprise at least one of: highlighting by spatially displacing the highlighted visual identifier from the stack of displayed visual identifiers, highlighting by changing the size of the highlighted visual identifier, highlighting by changing at least one colour of the highlighted visual identifier, highlighting by changing the spatial image resolution of the highlighted visual identifier. The data items may represent contact information in an address book

Hence the disclosed embodiments include a method which may use the created avatar visual identifiers to simplify the displaying of entries in an address book, and to simplify the displaying of searched contacts in an address book.

The method may further comprise retrieving at least one respective category indicator from the at least one set of data items; wherein the displaying of the subset of visual identifiers further comprises highlighting at least one second subset of visual identifiers, wherein the at least one second subset corresponds to the at least one respective category indicator.

Hence there is provided a method in which a user may order e.g. contacts in an address book according to different categories (such as friends, family, colleagues, contacts will special importance, etc.).

The method may further comprise receiving user input corresponding to at least one search term; selecting one subset of visual identifiers, wherein the members of the selected subset of visual identifiers are associated with the at least one search term; and highlighting the selected subset of visual identifiers.

Hence there is provided a method which will simplify the displaying of search results from a user query.

According to a fifth aspect of the disclosed embodiments there is provided a mobile communication device comprising circuitry configured to receive at least one set of data items; associate items from the at least one set of data items with visual identifiers; display a subset of visual identifiers along a path on a display, wherein members of the subset of visual identifiers are stacked in at least one stack of visual identifiers; detect a first user input and calculate a position on the display based on the detection of the first user input; highlight a member of the displayed stacked subset of visual identifiers on the display, wherein the highlighted visual identifier corresponds to the calculated position on the display; and detect a second user input representing a selection of the highlighted visual identifier, extract further data from the selected data item represented by the highlighted visual identifier and display the further data on the display.

### BRIEF DESCRIPTION OF THE DRAWINGS

The above, as well as additional features and advantages of the disclosed embodiments, will be better understood through the following illustrative and non-limiting detailed description of preferred embodiments, with reference to the appended drawings, where the same reference numerals will be used for similar elements, wherein:

FIG. 1 is a schematic illustration of a cellular telecommunication system, as an example of an environment in which the disclosed embodiments may be applied.

FIG. 2 is a schematic front view illustrating a mobile terminal according to an embodiment.

FIG. 3 is a schematic block diagram representing an internal component, software and protocol structure of the mobile terminal shown in FIG. 2.

FIGS. 4a-b are flow charts illustrating a method for creating avatar visual identifiers of contacts in an address book and for searching contact information in an address book, respectively, according to an embodiment.

FIGS. 5a-d are schematic display views of avatar visual identifiers according to an embodiment.

FIG. 6 is a flow chart illustrating a method for facilitating extraction of a data item from a set of data items according to an embodiment.

FIG. 7 is a schematic display view of a visual navigation aid according to an embodiment.

FIGS. 8a-c are schematic views of visual navigation stacks according to different embodiments.

FIGS. 9a-b are schematic display views of visual navigation aids according to different embodiments.

### DETAILED DESCRIPTION OF PREFERRED EMBODIMENTS

The disclosed embodiments have mainly been described above with reference to a few embodiments. However, as is readily appreciated by a person skilled in the art, other embodiments than the ones disclosed above are equally possible within the scope of the disclosed embodiment, as defined by the appended patent claims.

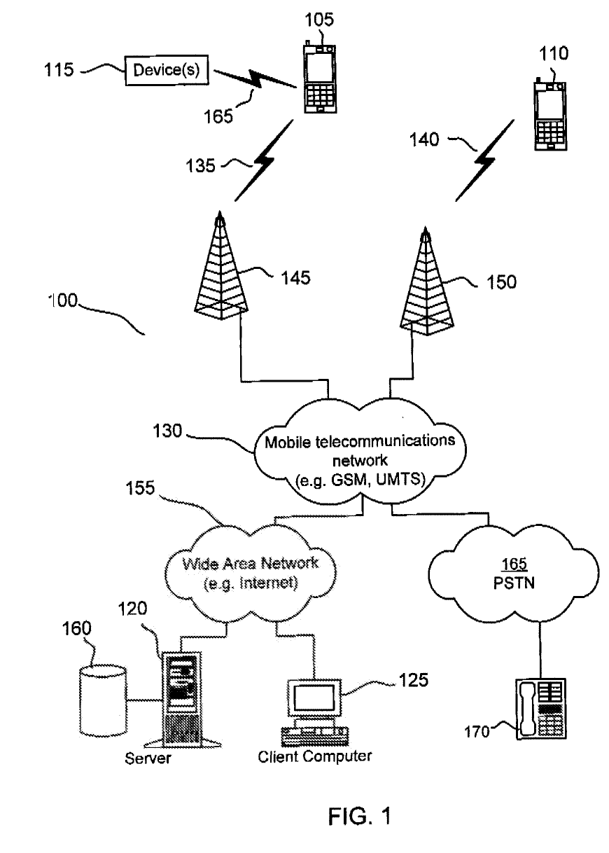

FIG. 1 illustrates an example of a cellular telecommunications system 100 in which the disclosed embodiments may be applied. In the telecommunication system 100 of FIG. 1, various telecommunications services such as cellular voice calls, www/wap browsing, cellular video calls, data calls, facsimile transmissions, music transmissions, still image transmissions, video transmissions, electronic message transmissions, electronic positioning information, and electronic commerce may be performed between a mobile communication device 105 according to the disclosed embodiments and other devices, such as another mobile communication device 110, a local device 115, a computer 120, 125 or a stationary telephone 170. It is to be noted that for different embodiments of the mobile terminal 105 and in different situations, different ones of the telecommunications services referred to above may or may not be available; the disclosed embodiments are not limited to any particular set of services in this respect.

The mobile communication devices 105, 110 are connected to a mobile telecommunications network 130 through RF links 135, 140 via base stations 145, 150. The base stations 145, 150 are operatively connected to the mobile telecommunications network 130. The mobile telecommunications network 130 may be in compliance with any commercially available mobile telecommunications standard, such as GSM, UMTS, D-AMPS, CDMA2000, FOMA and TD-SCDMA.

The mobile telecommunications network 130 is operatively connected to a wide area network 155, which may be Internet or a part thereof. An Internet server 120 has a data storage 160 and is connected to the wide area network 155, as is an Internet client computer 125. The server 120 may host a www/wap server capable of serving www/wap content to the mobile communication devices 105, 110.

A public switched telephone network (PSTN) 165 is connected to the mobile telecommunications network 130 in a familiar manner. Various telephone terminals, including the stationary telephone 170, are connected to the PSTN 165.

The mobile communication device 105 is also capable of communicating locally via a local link 165 to one or more local devices 115.

The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, and communications aided by the infrared data association (IrDA) standard, etc.

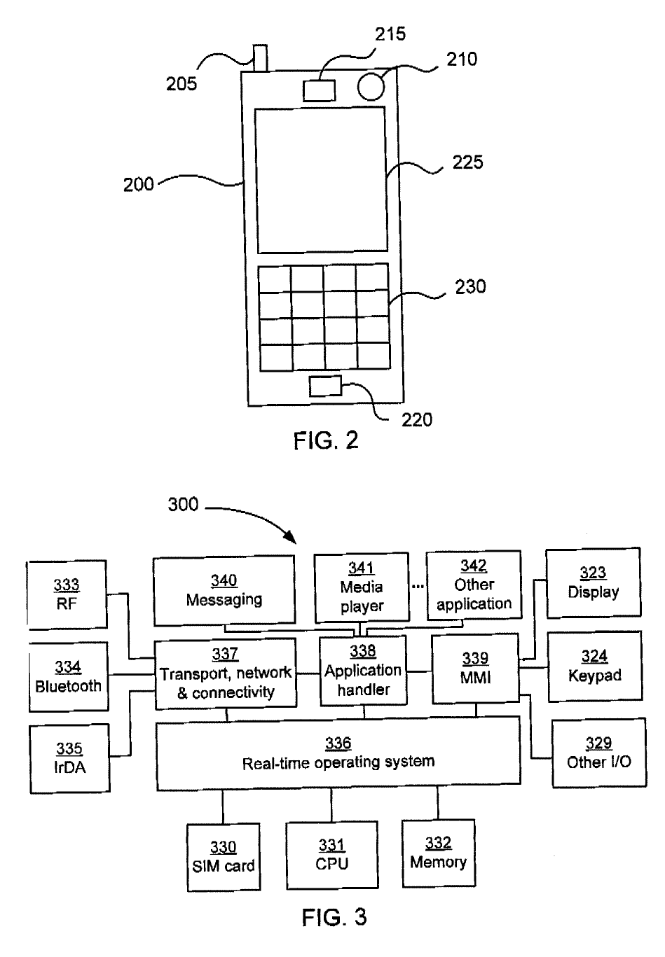

An embodiment 200 of the mobile communication device 105 is illustrated in more detail in FIG. 2. The mobile communication device 200 comprises an antenna 205, a camera 210, a speaker or earphone 215, a microphone 220, a display 225 and a set of keys 230 which may include a keypad of common ITU-T type (alpha-numerical keypad representing characters “0”-“9”, “*” and “#”) and certain other keys such as soft keys, and a joystick or other type of navigational input device (not explicitly illustrated). The mobile communication device 200 may be e.g. a mobile phone or a personal digital assistant (PDA).

The internal components 300, software and protocol structures of the mobile communication device 200 will now be described with reference to FIG. 3. The mobile communication device has a controller 331 which is responsible for the overall operation of the mobile terminal and is preferably implemented by any commercially available CPU (“Central Processing Unit”), DSP (“Digital Signal Processor”) or any other electronic programmable logic device. The controller 331 has associated electronic memory 332 such as RAM memory, ROM memory, EEPROM memory, flash memory, or any combination thereof. The memory 332 is used for various purposes by the controller 331, one of them being for storing data and program instructions for various software in the mobile terminal, such as data and program instructions corresponding to the disclosed embodiments for visual navigation. The software includes a real-time operating system 336, drivers for a man-machine interface (MMI) 339, an application handler 338 as well as various applications. The applications can include a messaging application 340 for sending and receiving SMS, MMS or email, a media player application 341, as well as various other applications 342, such as applications for voice calling, video calling, web browsing, an instant messaging application, a phone book application, a calendar application, a control panel application, a camera application, one or more video games, a notepad application, a positioning application, an application for creating visual identifiers, an application for searching visual identifiers, etc.

The MMI 339 also includes one or more hardware controllers, which together with the MMI drivers cooperate with the display 323, 225, keypad 324, 230, as well as various other I/O devices 329 such as microphone 220, speaker 215, vibrator, ringtone generator, LED indicator, etc. As is commonly known, the user may operate the mobile terminal through the man-machine interface thus formed.

The software also includes various modules, protocol stacks, drivers, etc., which are commonly designated as 337 and which provide communication services (such as transport, network and connectivity) for an RF interface 333, and optionally a Bluetooth interface 334 and/or an IrDA interface 335 for local connectivity. The RF interface 333 comprises an internal or external antenna as well as appropriate radio circuitry for establishing and maintaining a wireless link to a base station (e.g. the link 135 and base station 145 in FIG. 1). As is well known to a person skilled in the art, the radio circuitry comprises a series of analogue and digital electronic components, together forming a radio receiver and transmitter. These components include, e.g., band pass filters, amplifiers, mixers, local oscillators, low pass filters, AD/DA converters, etc.

The mobile communication device 200 as represented by the internal components 300 in FIG. 3 may also have a SIM card 330 and an associated reader. As is commonly known, the SIM card 330 comprises a processor as well as local work and data memory.

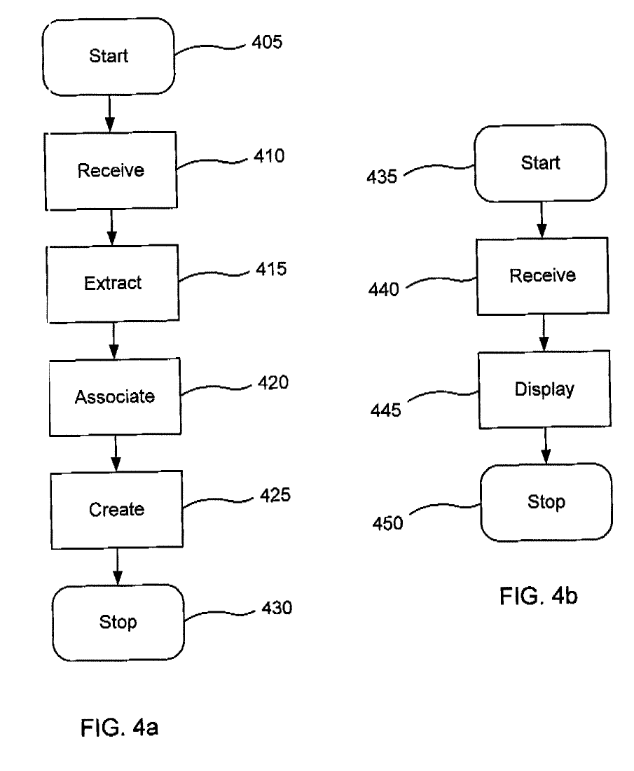

FIG. 4a is a flow chart illustrating a process for creating avatar visual identifiers of contacts in an address book according to an embodiment. After an application for creating avatar visual identifiers of contacts in an address book has been started 405 the method comprises receiving 410 contact information, which contact information corresponds to an entry in an address book, extracting 415 contact parameters associated with the contact information, associating 420 the contact parameters with avatar identification parameters, and creating 425 an avatar visual identifier for the contact information using the avatar identification parameters, wherein the avatar visual identifier has a one-to-one mapping to said contact information. The application may then stop 430.

FIG. 4b is a flow chart illustrating a process for searching contact information in an address book according to an embodiment. After an application for searching contact information in an address book has been started 435 the method comprises receiving 440 user input representing search terms for an avatar visual identifier, wherein the search terms correspond to avatar identification parameters, wherein the avatar visual identifier has a one-to-one mapping to contact information, and wherein the contact information corresponds to an entry in an address book; and displaying 445 the avatar visual identifier as an image, wherein the image is displayed along the contact information, and wherein the avatar visual identifier has a one-to-one mapping to the contact information. The application may then stop 450.

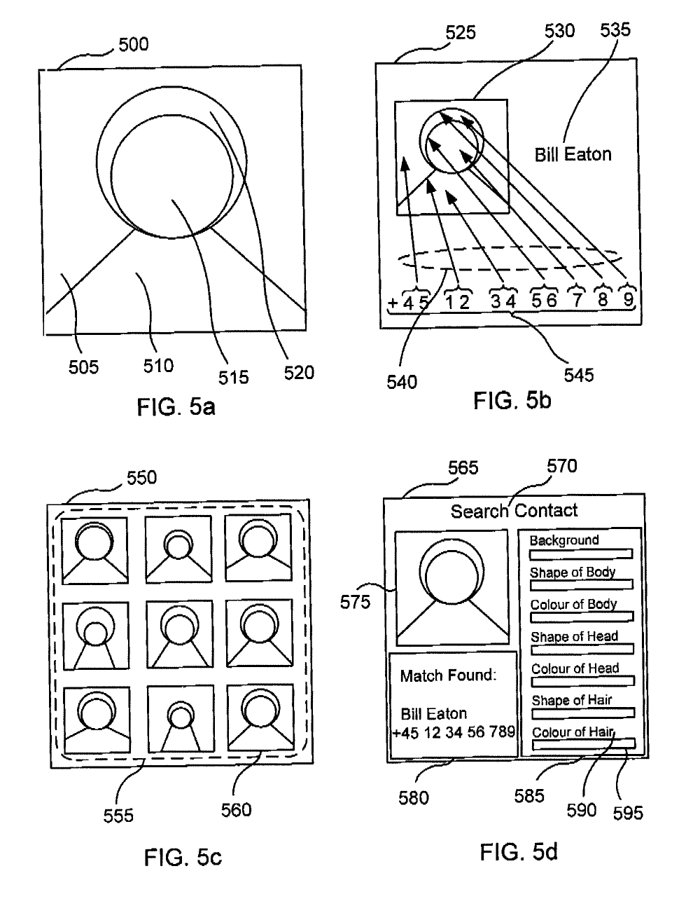

Moving on to FIG. 5 which shows schematic display views of avatar visual identifiers according to the disclosed embodiments. Focusing first on FIG. 5a which shows an avatar visual identifier 500 created according to the process of the flow chart in FIG. 4a, comprising a head 515, which head has a shape, a colour and hair 520, wherein the hair 520 also has a shape and a colour. The head 515 is furthermore attached to a body 510, which body has a shape and a colour. The avatar visual identifier 500 further comprises a background 505, which background has a colour. Note that avatar visual identifiers according to the disclosed embodiments are not constrained only to contain features from the list head, hair, body, and background. For example, to increase user experience and pleasure facial features, such as eyes, a nose, and a mouth could be added as well to create more life-like avatar visual identifiers and thereby increasing and improving user experience.

Thus different avatar visual identifiers can be created by assigning values to the properties shape and colour of respective avatar identification parameters. For example in the case of creating avatar visual identifiers for entries in an address book one may map (the mathematical terms “map” and “mapping” are used equivalently to the terms “associate” and “associating”, respectively—they can also be used to denote the noun “association”) certain parameters contained in the contact information of said address book to the different parameters of the avatar visual identifiers as discussed above. FIG. 5b shows one example of such a mapping in form of a schematic display view 525. The schematic display view 525 comprises an avatar visual identifier 530, such as the avatar visual identifier 500 of FIG. 5a. It further comprises contact information parameters of an entry in e.g. an address book, said contact information comprising a name 535 and a telephone number 545. In this case the entry in the address book contains the name “Bill Eaton” and the associated telephone number “+45123456789”. As is known to a person skilled in the art address book entries may further comprise e.g. an alias, one or more email addresses, one or more addresses, one or more additional telephone and fax numbers.

FIG. 5b shows how the telephone number 545 is mapped to different parameters of the avatar visual identifier 530 by the mapping schematically indicated by a dashed ellipsis 540, i.e. by using arrows from at least one digit of the telephone number 545 to properties of the avatar visual identifier 530. In FIG. 5b the digits “45” of the telephone number “+45123456789” define the colour of the background 505 of FIG. 5a, the digits “12” determine the shape of the body 510 of FIG. 5a, the digits “34” determine the colour of the body 510 of FIG. 5a, the digits “56” determine the shape of the head 515 of FIG. 5a, the digit “7” determines the colour of the head 515 of FIG. 5a, the digit “8” determine the shape of the hair 520 of FIG. 5a, and the digit “9” determine the colour of the hair 520 of FIG. 5a. It should be noted that the disclosed embodiments are not limited to assigning values to avatar visual identifier parameters from digits in a telephone number; the avatar visual identifier parameters may be assigned values from any contact information parameters in the address book.

Since all entries of the address book are assumed to be unique, which is normally the case, the contact information parameters will also be unique and therefore the avatar visual identifiers will be unique. Hence each avatar visual identifier has a one-to-one mapping to each corresponding entry in the address book. The avatar visual identifier 500 may be saved in a memory 332 of the mobile communication device 200 of FIG. 2 or it may be created on the fly as the contact is browsed according to a user input (e.g., by a user entering at least one key on the keypad 230 of the mobile communication device 200 of FIG. 2, or by a user using a touch display if the display 225 of the mobile communication device 200 of FIG. 2 has a touch display functionality) in the address book.

It should be noted that the avatar visual identifiers associated with the address book entries do not need to be transferred from one mobile communication device to another when, for example, a user may choose to move his/her SIM card 330, wherein the SIM card 330 comprises the address book, from one mobile communication device to another. The reason is that since the avatar visual identifiers are unique they can be re-created from the entries of the address book at any time and hence the unique avatar visual identifiers are not lost during data transfer between different communication devices. Thus the disclosed embodiments do not require an active data connection for downloading avatar visual identifiers, nor does it require the installation of separate files onto the mobile communication device.

Avatar visual identifiers may be used as icons for contacts on displays of mobile communication devices, such as the display 225 of the mobile communication device 200 in FIG. 2 as discussed above. This is illustrated in FIG. 5c which shows a schematic display view 550 consisting of a set 555 of nine (9) unique avatar visual identifiers, as exemplified by the avatar visual identifier icon 560. At least one such a set 555 of avatar visual identifier icons 560 may be used to simplify browsing of contacts in an address book of a mobile communication device 200.

Visual avatar identifiers may also be used to simplify the search for contacts in an address book. An embodiment created according to the process of the flow chart in FIG. 4b is illustrated in FIG. 5d which figure shows a schematic display view 565 consisting of a title 570, said title reading “Search Contact”, said display view further comprising a search form 585, a window 580 displaying contact information for a matched contact, and a corresponding avatar visual identifier 575. The search form 585 comprises fields 595 for search terms 590, which search terms correspond to the parameters which define the avatar visual identifier 575. The search terms of the field 585 in FIG. 5d correspond to avatar visual identifiers having a background with a colour, a body having a shape and a colour, a head having a shape and a colour, and hair having a shape and a colour. Each search field, such as the search field 595, comprises means for receiving user input, such as e.g. a drop list or an entry field. The user input will thus define the feature parameters of an avatar visual identifier 575 e.g., by entering at least one key on the keypad 230 of the mobile communication device 200 of FIG. 2, or by using a touch display if the display 225 of the mobile communication device 200 of FIG. 2 has a touch display functionality. Using an inverse mapping a corresponding contact can be deduced from the avatar visual identifier since there is a one-to-one mapping from contact information parameters to avatar visual identifiers. In the exemplary case as displayed in FIG. 5d a match has been found and is displayed in the window 580, wherein the contact information according to a name “Bill Eaton” and a telephone number “+45123456789” is displayed. If there is no perfect match but instead several resulting close matches a list of these close matches may be displayed. For example, if a user searches for a background with parameter value “2” and there is no contact in the address book having a corresponding background parameter equal to “2” but instead three contacts in the address book having a corresponding background parameter equal to “3” the user may choose to display these three entries on the display. One should note that an avatar visual identifier is defined by a multitude of parameters and hence it is possible for two unique avatar visual identifier to share all but one common parameter value.

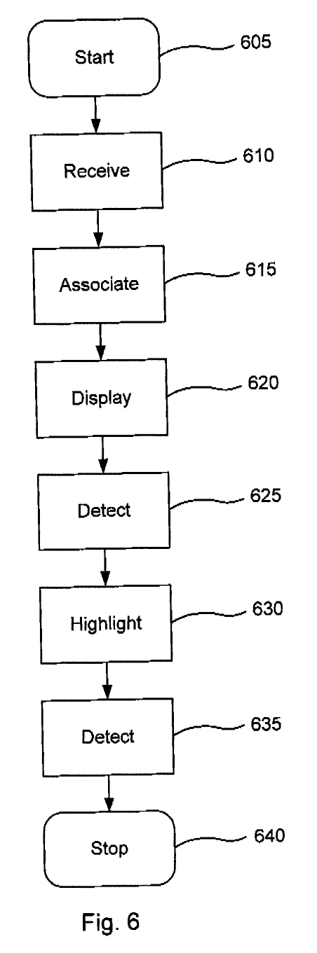

FIG. 6 is a flow chart illustrating a process for facilitating extraction of a data item from a set of data items according to an embodiment. After an application for facilitating extraction of a data item from a set of data items has been started 605 the method comprises receiving 610 at least one set of data items; associating 615 items from the at least one set of data items with visual identifiers; displaying 620 a subset of visual identifiers along a path on a display, wherein members of the subset of visual identifiers are stacked in at least one stack of visual identifiers; detecting 625 a first user input and calculating a position on the display based on the detection of the first user input; highlighting 630 a member of the displayed stacked subset of visual identifiers on the display, wherein the highlighted visual identifier corresponds to the calculated position on the display; and detecting 635 a second user input representing a selection of the highlighted visual identifier, extracting further data from the selected data item represented by the highlighted visual identifier and displaying the further data on the display. The application may then stop 640.

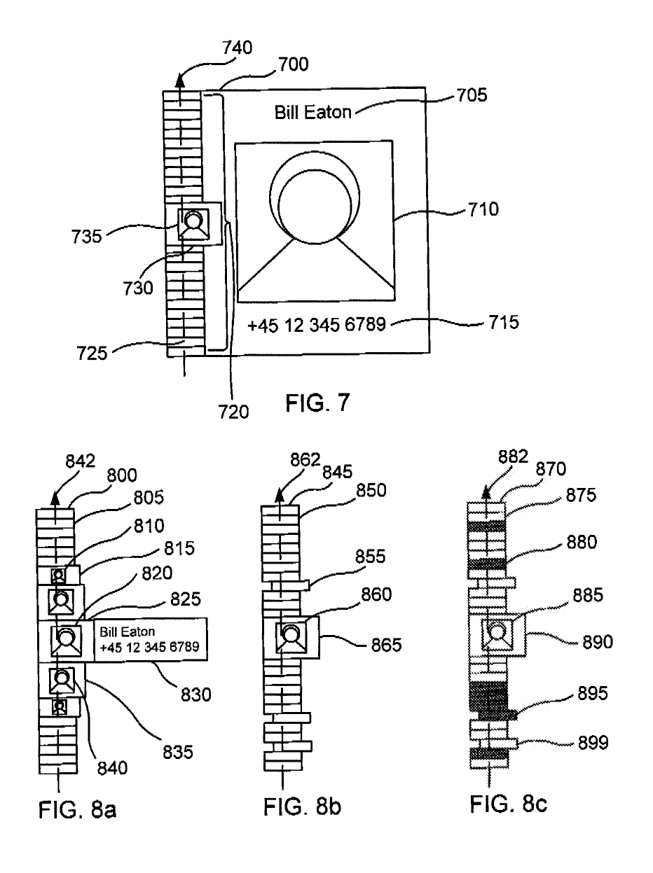

FIG. 7 is a schematic display view 700 of a visual navigation aid created according to an embodiment of the process of the flow chart of FIG. 6. The display view 700 comprises a visual navigation stack 720, which stack comprises a subset of stacked visual identifiers stacked along a (virtual) path 740 in the display. The stacked visual identifiers correspond to a set of data items, said set of data items comprising individual data items 725. The stack 720 further comprises a selected and highlighted data item 730, which item comprises a visual identifier icon 735.

In FIG. 7 the data item 730 has been highlighted by having an increased size in comparison to an individual data item 725. However, the highlighting of visual identifiers may comprise at least one of: highlighting by spatially displacing the highlighted visual identifier from the stack of displayed visual identifiers, highlighting by changing the size of the highlighted visual identifier, highlighting by changing at least one colour of the highlighted visual identifier, highlighting by changing the spatial image resolution of the highlighted visual identifier.

The display view 700 further comprises a visual identifier 710 corresponding to the selected and highlighted data item 730, said visual identifier 710 being associated with further data such as contact information for a contact in an address book, which in the exemplary case of FIG. 7 consist of a name 705, “Bill Eaton”, and a corresponding phone number 715, “+45123456789”. The visual identifier 710 may be an avatar visual identifier of the form 500 as described with reference to FIG. 5a. A user may scroll the stack 720 along the (virtual) path 740 according to a first user input. Such a scrolling will highlight a next item along the (virtual) path 740. After receiving a second user input representing a selection a visual identifier and further data corresponding to the highlighted next item will be displayed. It should be obvious to a person skilled in the art that after such a selection a user may input a third input corresponding to further processing of said further data, such as calling or sending an SMS to the selected contact, etc.

One advantage with the visual navigation aid of FIG. 7 is that a user is able to estimate the size of the visual navigation stack 720 and thus if the entries 725 of the navigation stack 720 correspond to entries in an address book the user may estimate the size of the address book. In the same line of reasoning a user may easily estimate the position of the highlighted item in the visual navigation stack 720. The individual data items 725 of FIG. 7 may change in size with the number of entries in the address book. It is also possible only to display a subset of data items (i.e. corresponding to a subset of the address book).

FIGS. 8a-c are schematic views of visual navigation stacks 800, 845, 870 according to different embodiments. Each such stack can be used in accordance with the visual navigation aid 700 of FIG. 7.

In FIG. 8a the stack 800 comprises individual data items 805 located in a stack along a (virtual) path 842 and a highlighted data item 825. The highlighted data item may further comprise a visual identifier icon 820 and may be associated with a window 830 comprising contact information for an address book entry corresponding to the selected and highlighted data item 825. The stack 800 further comprises data items 835, 815 comprising visual identifier icons 840, 810, wherein the size of the data items 835, 815 decreases as the distance between the data items 835, 815 and the selected and highlighted data item 825 increases. A distance in a stack along the (virtual) path 842 between a first data item and a second data item is here defined as the number of data items between the first data item and the second data item. Thus as can be noted in the stack 800 data item 835 is displayed larger than data item 815 since data item 835 is adjacent to the selected and highlighted data item 825 (i.e. the distance is zero) and the distance between the data item 815 and the selected and highlighted data item 825 is one (1) distance unit. As can be noted in the figure only data items with a maximum distance of one distance unit have been increased in size compared to the individual data items 805, however the method according to the disclosed embodiments extends to increasing this threshold distance.

Continuing now with FIGS. 8b-c which comprise stacks 845, 870, said stacks further comprising individual data items 850, 875 located in a stack along a (virtual) path 862, 882 and selected highlighted data items 865, 890. The selected highlighted data items further comprises visual identifier icons 860, 885. The stacks 845, 870 further comprise data items 855, 899, 880, 895 which have been highlighted (but not selected) according to at least one respective category indicator.

As discussed above there are many ways to highlight data items in a stack of items. In FIG. 8b highlighted (but not selected) data items are indicated by being spatially displaced (data item 855) compared to non-selected, non-highlighted data items (such as the data item 850). In FIG. 8c two respective category indicator functions have been used in order to highlight (but not select) individual data items. For example the colour of the highlighted data item 880 has changed, whereas data item 899 has been spatially displaced. Data item 895 has been spatially displaced and its colour has changed.

Highlighted (but not selected) data items, such as the data item 855 of the stack 845 may correspond to contacts which are frequently used, or they may be considered as having a high importance by a user. Selection criteria, as defined by said at least one respective category indicator may be defined by a user. The functionality may also be provided by the mobile communication device or as a service provided by a telecommunications operator. Category indicators may also be defined according to at least one search criteria for e.g. entries in an address book.

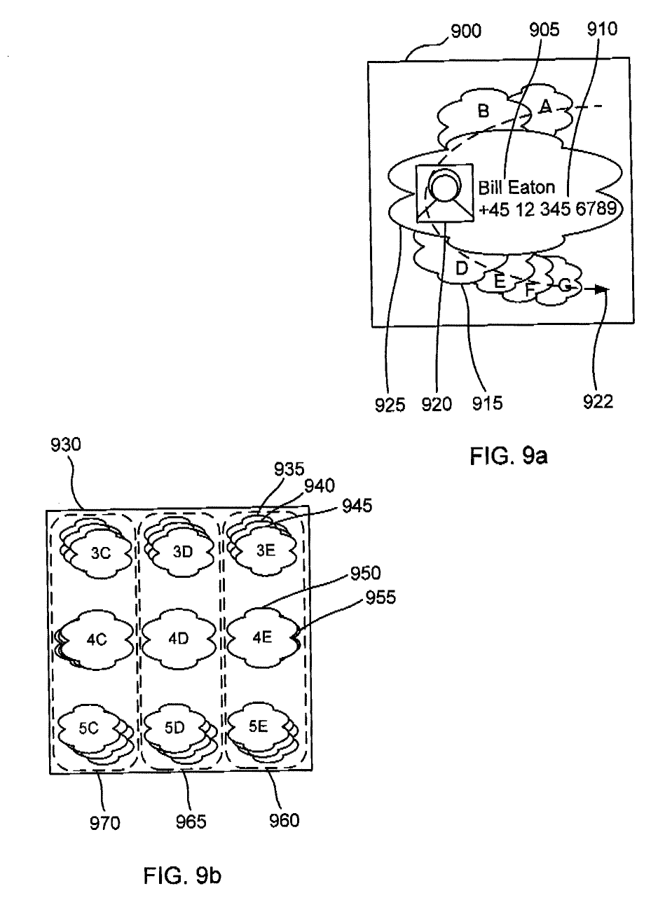

Finally, FIGS. 9a-b are schematic display views 900, 930 of visual navigation aids according to different embodiments. Starting with the display view 900 of FIG. 9a which comprises data items 915 (schematically named A, B, D, E, F, G) and a selected and highlighted data item 925. The selected and highlighted data item 925 further comprises a visual identifier 920 and contact information (a name 905 “Bill Eaton” and a telephone number 910 “+45123456789”) for e.g. an entry in an address book. A user may scroll the stack comprising the data items A, B, D, E, F, G and the selected and highlighted data item 925 along a curved (virtual) path 922 according to a first user input. Such a scrolling will highlight a next item (in FIG. 9a either data item B or data item D) in the curved (virtual) path 922. In the example shown in FIG. 9a the selected and highlighted data item is data item number three (3) from the top of the stack and the stack comprises seven (7) data items in total.

The display view 930 of FIG. 9b comprises a number of data items ordered in three vertically aligned stacks 970, 965, 960. Each such stack 970, 965, 960 comprises individual data items 935, 940, 945, 955 and highlighted data items 950, and as can be noted in the figure one data item (schematically named 4C, 4D, 4E) from each stack 970, 965, 960 is highlighted simultaneously. In the example of FIG. 9b each stack 970, 965, 960 comprises seven (7) individual data items in total. Data items ordered next to the highlighted data items in each stack are schematically denoted 3C, 3D, 3E in the vertical up direction and 5C, 5D, 5E in the vertical down direction. As can be noted in the figure the (hidden) data item 955 is aligned behind the highlighted data item 950 of the rightmost displayed stack 960. The (hidden) data item 955 symbolizes a data item of a hidden data stack comprising data elements 1F-7F aligned to the right of the stack 960. In the same way there are two (hidden) data items symbolizing two hidden data stacks comprising data elements 1A-7A and 1B-7B aligned to the left of the leftmost displayed stack 970.

A user may scroll a stack in a vertical direction (e.g. from data item 4C to data item 3C) or a user may scroll between stacks in a horizontal direction (e.g. from data item 4C to data item 4D) according to a user input. If the scrolling is in a vertical direction a new row of data elements will be highlighted. If the scrolling is in a horizontal direction a new previously hidden stack may be displayed; this will e.g. be the case if data item 4C of the stack 970 is presently highlighted and a user input representing a scrolling to the left is detected. Such a scrolling will move stacks 970 and 965 one step to the right on the display view 930, i.e. stack 970 will replace stack 965 and stack 965 will replace stack 960, while stack 960 will be hidden and a previously hidden stack (comprising data elements 2A-7A) will replace stack 970. Each individual data item of the stacks may correspond to contact information for an entry in an address book. For example the stack 970 may comprise the names of the entries while the stack 965 comprises corresponding phone numbers and stack 960 comprises corresponding email addresses.

Below follows a number of scenarios where the disclosed embodiments are used to simplify visual navigation.

### Scenario 1: (Creating Avatar Visual Identifiers)

A user has installed an application for creating avatar visual identifiers of contacts on his/her mobile communication device. The application automatically generates unique avatar visual identifiers for all contacts in the address book according to the names of the address book contacts. The user may then browse the address book by browsing the corresponding avatar visual identifiers.

### Scenario 2: (Transferring Contact Information)

A user has bought a new mobile communication device and uses a SIM card to transfer address book contacts from the old mobile communication device to the new. The user has previously created unique avatar visual identifiers for his/her contacts on the old mobile communication device (see Scenario 1 above), but the avatar visual identifiers need not to be transferred from the old mobile communication device to the new device by e.g. using the SIM card since the avatar visual identifiers will be created automatically on the new device, assuming that the new device comprises an installed application for creating avatar visual identifiers. The avatar visual identifiers are unique and since the contact information does not changed during transfer from one device to another, the avatar visual identifiers will be identical in both devices.

### Scenario 3: (Categorizing Contacts in an Address Book)

A user may order contacts in an address book by assigning category indicators to the contacts. For example a user may choose to assign a first category indicator to all colleagues and a second category indicator to all family members. When browsing an address book a user may easily find contacts from a specific category group if the contacts are represented by visual indicators and the visual indicators corresponding to contacts of different categories have been highlighted, as in FIG. 8c.

### Scenario 4: (Searching Contacts in an Address Book)

A user wants to find all entries in his/her address book which names (either first name, or family name, or both) starts with the letter “K”. The user enters the letter “K” in a search function and the address book is displayed as a stack, in which stack all entries staring with the letter “K” are highlighted.

Generally, all terms used in the claims are to be interpreted according to their ordinary meaning in the technical field, unless explicitly defined otherwise herein. All references to “a/an/said/the [device, component, etc]” are to be interpreted openly as referring to at least one instance of said device, component, etc., unless explicitly stated otherwise. The steps of any method disclosed herein do not have to be performed in the exact order disclosed, unless explicitly stated.

1. A method for creating avatar visual identifiers of contacts in an address book, comprising
receiving contact information, which contact information corresponds to an entry in an address book,
extracting contact parameters associated with said contact information,
associating said contact parameters with avatar identification parameters, and
creating an avatar visual identifier for said contact information using said avatar identification parameters, wherein said avatar visual identifier has a one-to-one mapping to said contact information.

2. The method according to claim 1, further comprising
displaying said avatar visual identifier as an image.

3. The method according to claim 2, further comprising
displaying said contact information along said avatar visual identifier.

4. The method according to claim 1, wherein said contact information is at least one item from the list: phone number, address, email address, name, alias.

5. The method according to claim 2, wherein said image comprises at least one item from the group of: a head with hair, said head having a shape and a colour, said hair having a shape and a colour, said head being attached to a body, said body having a shape and a colour, said image further comprises a background, said background having a colour, and wherein said avatar identification parameters correspond to items from the list: shape of head, shape of body, shape of hair, colour of head, colour of body, colour of hair, colour of background.

6. The method according to claim 1, wherein said one-to-one mapping is a predetermined one-to-one mapping.

7. The method according to claim 1, wherein said one-to-one mapping is defined by:
receiving user input representing a one-to-one mapping from said contact parameters to said avatar identification parameters.

8. A method for searching contact information in an address book, comprising
receiving user input representing search terms for an avatar visual identifier, said search terms corresponding to avatar identification parameters, wherein said avatar visual identifier has a one-to-one mapping to contact information, and wherein said contact information corresponds to an entry in an address book; and
displaying said avatar visual identifier as an image, said image being displayed along said contact information, wherein said avatar visual identifier has a one-to-one mapping to said contact information.

9. The method according to claim 8, wherein said contact information is at least one item from the list: phone number, address, email address, name, alias.

10. The method according to claim 8, wherein said image comprises at least one item from the group of: a head with hair, said head having a shape and a colour, said hair having a shape and a colour, said head being attached to a body, said body having a shape and a colour, said image further comprises a background, said background having a colour, and wherein said avatar identification parameters correspond to items from the list: shape of head, shape of body, shape of hair, colour of head, colour of body, colour of hair, colour of background.

11. A mobile communication device comprising circuitry configured to
receive contact information, which contact information corresponds to an entry in an address book,
extract contact parameters associated with said contact information,
associate said contact parameters with avatar identification parameters, and
create an avatar visual identifier for said contact information using said avatar identification parameters, wherein said avatar visual identifier has a one-to-one mapping to said contact information.

12. A computer program product, comprising computer program code stored on a computer-readable storage medium which, when executed on a processor, carries out the method according to claim 1.

13. A method for facilitating extraction of a data item from a set of data items, comprising
receiving at least one set of data items;
associating items from said at least one set of data items with visual identifiers;
displaying a subset of visual identifiers along a path on a display, wherein members of said subset of visual identifiers are stacked in at least one stack of visual identifiers;
detecting a first user input and calculating a position on said display based on said detection of said first user input;
highlighting a member of said displayed stacked subset of visual identifiers on said display, wherein said highlighted visual identifier corresponds to said calculated position on said display; and
detecting a second user input representing a selection of said highlighted visual identifier, extracting further data from the selected data item represented by said highlighted visual identifier displaying said further data on said display.

14. The method according to claim 13, wherein said subset members of visual identifiers have a size and at least one colour, and wherein said highlighting of visual identifier comprises at least one of: highlighting by spatially displacing said highlighted visual identifier from said stack of displayed visual identifiers, highlighting by changing the size of said highlighted visual identifier, highlighting by changing at least one colour of said highlighted visual identifier, highlighting by changing the spatial image resolution of said highlighted visual identifier.

15. The method according to claim 13, wherein
a distance along said path between a first visual identifier and a second visual identifier is defined as the number of data items between said first visual identifier corresponding to a first data item in said at least one set of data items and said second visual identifier corresponding to a second data item in said at least one set of data items; and
said displayed visual identifiers are displayed with at least two sizes, wherein the size of said displayed visual identifiers decrease as the distance between said displayed visual identifiers and said highlighted visual identifier increases.

16. The method according to claim 13, further comprising
retrieving at least one respective category indicator from said at least one set of data items; and wherein the displaying of said subset of visual identifiers further comprises
highlighting at least one second subset of visual identifiers, wherein said at least one second subset corresponds to said at least one respective category indicator, and wherein said highlighting of said at least one second subset of visual identifiers comprises at least one of: highlighting by spatially displacing said at least one second subset of highlighted visual identifiers from said stack of displayed visual identifiers, highlighting by changing the size of said at least one second subset of highlighted visual identifiers, highlighting by changing at least one colour of said at least one second subset of highlighted visual identifiers, highlighting by changing the spatial image resolution of said at least one second subset of highlighted visual identifiers.

17. The method according to claim 13, further comprising
receiving user input corresponding to at least one search term;
selecting a subset of visual identifiers, wherein the members of said selected subset of visual identifiers are associated with said at least one search term; and
highlighting said selected subset of visual identifiers by any of: spatially displacing said selected subset of visual identifiers from the stack of visual identifiers, changing the size of the member of said selected subset of visual identifiers in said stack, changing the colour of said selected subset of visual identifiers in said stack, changing the spatial image resolution of said selected subset of visual identifiers in said stack.

18. The method according to claim 13, wherein said data items represent contact information in an address book, the method further comprising
displaying said contact information together with said highlighted visual identifier, wherein said data item corresponds to said highlighted visual identifier.

19. The method according to claims 18, wherein
said visual identifiers are avatar visual identifiers according to the method of claim 1.

20. A mobile communication device comprising circuitry configured to
receive at least one set of data items;
associate items from said at least one set of data items with visual identifiers;
display a subset of visual identifiers along a path on a display, wherein members of said subset of visual identifiers are stacked in at least one stack of visual identifiers;
detect a first user input and calculate a position on said display based on said detection of said first user input;
highlight a member of said displayed stacked subset of visual identifiers on said display, wherein said highlighted visual identifier corresponds to said calculated position on said display; and
detect a second user input representing a selection of said highlighted visual identifier, extract further data from the selected data item represented by said highlighted visual identifier and display said further data on said display.

21. A computer program product, comprising computer program code stored on a computer-readable storage medium which, when executed on a processor, carries out the method according to claim 13.
